(19) United States
(12) Patent Application Publication
(10) Pub. No.: US 2007/0217594 A1
(43) Pub. Date: Sep. 20, 2007

(54) System and method for processing status information of peers in a communication network

(75) Inventors: Mario Giacometto, Selzach (CH); Guenter Kreis, Langendorf (CH)

Correspondence Address: MCCARTHY TETRAULT LLP, BOX 48, SUITE 4700,, 66WELLINGTON STREET WEST, TORONTO, ON, M5K 1E6, CA

(73) Assignee: Aastra Telecom Schweiz AG

(21) Appl. No.: 11/376,250

(22) Filed: Mar. 16, 2006

(51) Int. Cl. H04M 7/00

(52) U.S. Cl. 379/219

(57) ABSTRACT

The invention provides a system and method providing status information for a first device in a communication network to a second device. The system comprises: a database storing status information regarding availability of the first device; and a data access system providing the status information to the second device. The second device comprises: a lamp indicator providing a visual indication of the status; a display providing text information relating to the status; and software to control how the lamp indicator provides the visual indication and how the display provides the text information.

### FIELD OF INVENTION

The present invention relates to a system and method of processing status information of peers in a communication network. In particular, the invention relates to processing current status information of a user to the user's peers in a telephone network.

### BACKGROUND OF THE INVENTION

Many technologies provide voice communications and real-time non-voice communications between two or more people. Voice communications may be conducted through parties having telephones (or similar communication devices) connected on a public switched telephone network (PSTN), a private switched telephone network (PBX), a cellular telephone network or through a combination of the networks. Non-voice communications can be conducted by persons accessing appropriate terminals using data networks and data channels, such as email, short message service (SMS) and others. It is also common to have devices which incorporate both voice and non-voice capabilities (e.g. cell phones with SMS messaging capabilities).

Aside from a basic telephonic keypad, communication devices have additional features allowing them to better interact with other devices in such communication networks. For example, telephones also provide a set of function keys and a display. Typically, the function keys can be programmed to have different functions, for example, storing a preferred telephone number. Displays can show the telephone numbers of incoming calls. However, such features provide only limited amounts of information on other users. For example, the features do not provide detailed information about other users in the system. In particular, for an exemplary assistant and a boss, their two telephones may be linked together such that the assistant will know whether the boss is currently on the boss' telephone, but the assistant will not know what will happen to a call if the assistant tries to call the boss' telephone.

There is a need to address deficiencies in the prior art.

### SUMMARY

In a first aspect, a system for providing status information relating to a first communication device in a communication network is provided. The system comprises: a database storing status information regarding availability of the first communication device; a data access system to access the database in order to retrieve and transmit the status information; and a second communication device to receive the status information from the data access system. The second communication device comprises a display providing information relating to the status information; and software to control the indicator provides the visual indication and how the display provides the information. In the system if the first communication device is reachable, the display provides information regarding a manner in which the first communication device may be reached; and if the first communication device is not reachable, the display provides information indicating that the first communication device is not reachable.

In the system, the second device may further comprise a lamp indicator selectively providing a visual indication of the status information.

In the system, the lamp indicator may be located near the display and may provide the visual indication of the status information in conjunction with related status information generated on the display.

The system may further comprise availability information provided by an appointment program operating on a computer associated with the first communication device. The availability information may be provided to the second communication device by the data access system and may be displayed on the display of the second communication device.

The system may further comprise status information on a third communication device stored in the database that may be provided to the second communication device by the data access system.

In the system the availability information of the first communication device may indicate when the first communication device has had its telephone number forwarded to another number.

In the system, the availability information of the first communication device may indicate when the first communication device is connected to another call.

In the system, the second communication device may further comprise an interface to set an override value for a current status for the second communication device.

The system may further comprise: a second computer associated with the second communication device, the second computer being provided with the status information; and software operating on the second computer to access and display the status information on a display associated with the second computer.

In the system, a permission level providing a selectable amount of detail relating to the status information may be set at the second computer.

The system may further comprise a supervisor system external to the second computer setting the permission level.

In the system, the software operating on the second computer may provide the status information through a GUI. The GUI may utilize at least one of color, different icons and text to signify aspects of the status information.

In a second aspect, a method for providing status information to a communication device connected to a communication network relating to communication devices also connected to the communication network is provided. The method comprises: tracking current availability of each communication device utilizing status information associated with each device through the network; and providing to the communication device details regarding the current availability of each device information utilizing the status information. In the method, if each device is reachable, the details provide information regarding a manner in which each device may be reached; and if each device is not reachable, the details provide information indicating that each device is not reachable.

In the method, additional availability information may be provided from an appointment program operating on a computer associated with each device to the communication device.

In the method, the current availability may indicate when each device has had its telephone number forwarded to another number.

In the method, the current availability may indicate when each device is connected to another call.

In other aspects various combinations of sets and subsets of the above noted aspects are provided.

### BRIEF DESCRIPTION OF THE DRAWINGS

The foregoing and other aspects of the invention will become more apparent from the following description of specific embodiments thereof and the accompanying drawings which illustrate by way of example only the principles of the invention. In the drawings, where like elements feature like reference numerals (and wherein individual elements bear unique alphabetical suffixes):

FIG. 1 is a schematic diagram representation of a telephone network having a call management server, a plurality of local lines and a PBX network which are related to an embodiment of the invention;

FIG. 2 is a schematic representation of a building having the PBX network of FIG. 1 and a computer network which are provided in an embodiment of the invention;

FIG. 3A is a schematic representation of a telephone connected to the PBX network of FIG. 2 illustrating aspects of the embodiment;

FIG. 3B is a block diagram of components of the telephone of FIG. 3A;

FIG. 4A is a schematic representation of screen shot generated on a display of the telephone of FIG. 3;

FIG. 4B is a schematic representation of another screen shot generated on a display of the telephone of FIG. 3;

FIG. 4C is a schematic representation of yet another screen shot generated on a display of the telephone of FIG. 3;

FIG. 5 is a schematic representation of a computer associated with the telephone of FIG. 3A, illustrating more aspects of the embodiment; and

FIG. 6 is a schematic representation of screen shot generated on a display of the computer of FIG. 5.

### DETAILED DESCRIPTION OF EMBODIMENTS

The description which follows and embodiments described therein are provided by way of illustration of an example or examples of particular embodiments of the principles of the present invention. These examples are provided for the purposes of explanation and not limitation of those principles and of the invention. In the description which follows, like parts are marked throughout the specification and the drawings with the same respective reference numerals.

Briefly, an embodiment provides a communication device connected to a communication network. The device is provided with status information on a set of its peers. In one embodiment, a telephone is the device it knows whether a peer is on a call, not available, or available to take a call. A display and programmable function keys on the telephone provide information and interfaces to manage calls and monitor peers. Further features and elements of the embodiment are provided in the context of describing a telephone network below.

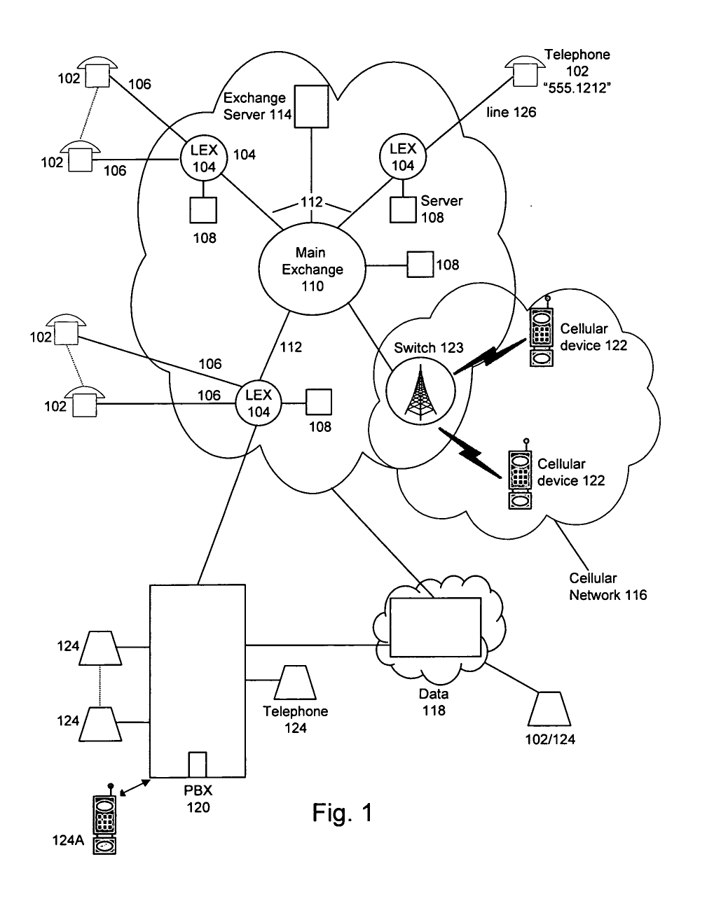

Referring to FIG. 1, telephone network 100 is shown. Network 100 connects telephones 102 to each other through a system of connected local exchanges (LEXs) 104, which act as hubs for network 100. Each line 106 is assigned a unique telephone number for that area code and exchange (e.g. 416-555-1212), providing that line 106 with a unique, numerical address for that exchange region of network 100. A LEX server 108 at each LEX 104 provides maintenance and call management features for its lines 106.

Telephones 102 connected at a same LEX 104 communicate with each other through the same LEX. In order to provide connections for telephones 102 between different LEXs 104, main exchange 110 is provided as a central connection point for all LEXs 104. Each LEX 104 has a high-capacity connection 112 to main exchange 110. As such, calls between telephones 102 connected to different LEXs 104 can be processed through exchange 110. Exchange server 114 monitors and maintains connections to LEXs 104.

Call management services for telephones 102 in network 100 may be handled co-operatively by servers 108 and 114. Such services include basic call management features (e.g. resource management, call processing features and bill tracking).

Additional communication networks, systems and devices can be connected to network 100, including cellular network 116, data network 118 and PBX 120. Cellular network 116 controls communications processed by cellular devices 122. Generally, devices 122 communicate through cellular switch 123 to each other and to other devices in network 100. Data network 118 may be a distributed network and may include a data server, web-enabled server or the like that provide additional features and data to elements in network 100. PBX 120 controls communications processed by local telephones 124. The operation and functions of PBX 120 are similar to functions provided to telephones 102 through network 100. It will be appreciated that devices which are connected to network 100 may share data and communicate with other devices in the network.

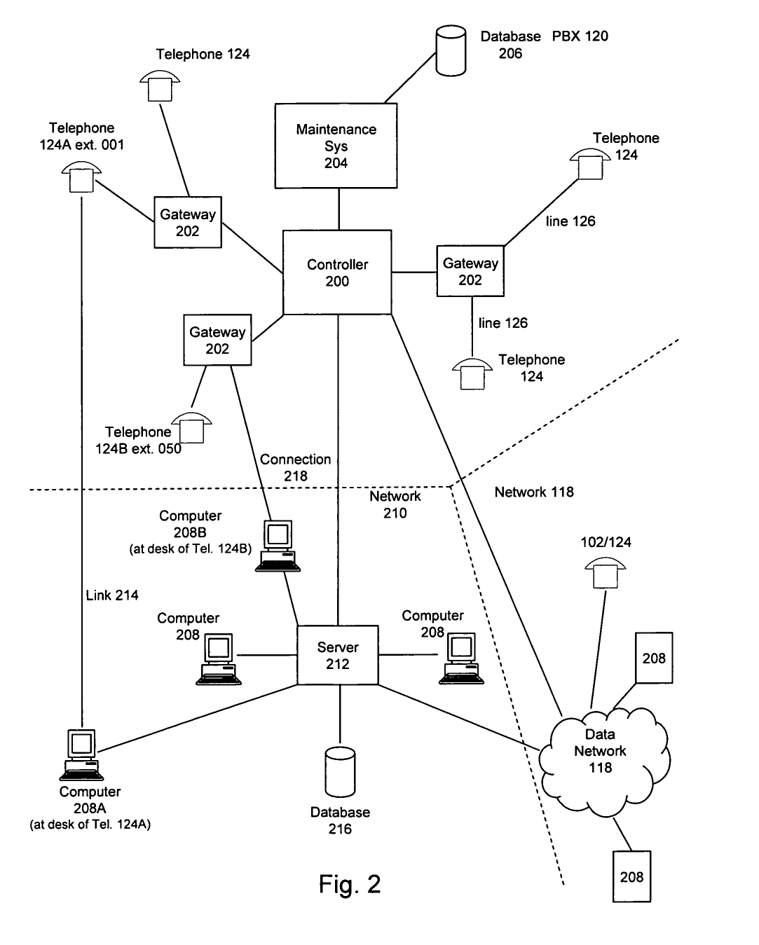

Referring to FIG. 2, further detail is provided on PBX 120, an associated computer network 210 and data network 118. PBX 120 is implemented as an system to control analog telephones; however, other devices may also be processed by it, including digital telephones, DEC-compatible handsets, IP-based telephones, cordless handsets, data devices and a combination of the devices.

A typical site for PBX 120 is an office building, having one or more floors. PBX controller 200 provides the main communication processing unit for telephones 124 associated with PBX 120. Each telephone 124 has a separate line 126 which is ultimately connected to controller 200. A set of lines may be connected to gateway 202 which in turn has a high-capacity connection to controller 200. A gateway 202 may be at a different physical location from controller 200 or may be integrated into controller 200. In a similar fashion to servers 108 and 114 of network 100 (FIG. 1), management system 204 provides call build, maintenance and tear down resources for calls initiated by telephones 124 and provides management of calls connecting to devices outside PBX 120, such as to telephones 102 and cellular phones 122.

Telephone numbers can be allocated to PBX 120 as a block of telephone numbers without extensions may be associated with PBX 120 (e.g. telephone numbers 416.555.0000, 416.555.0001 . . . to 416.555.0100) and each number may be assignable by PBX 120 to its telephones 124. This type of allocation is commonly used in European PBX systems. Alternatively, in another allocation scheme, a central number is associated with PBX 120 itself (e.g. 416.555.0000) and a block of extension numbers associated with the central number are assignable by PBX 120 to its connected telephones 124. For example, telephones 124 connected to PBX 120 may be assigned extensions between 001 and 999. As such, telephone 124A and line 126A may be assigned extension 001 and telephone 124B and line 126B may be assigned extension 050. Generally, the assignment is associated with the line 126 and not the telephone 124. System 204 tracks and manages the exchange numbers assigned to each line 126 and telephone 124.

System 204 also obtains current status information from telephones 124 and their related lines 126 by receiving, requesting or extracting status information from each telephone 124. Status information can be transmitted in status signals between system 204 and a telephone 124. For example, when a particular telephone 124 initially goes “off-hook”, it can generate and send a signal to management system 204. Similarly, when that telephone goes “on-hook”, it can generate and send another signal to management system 204. As such, by receiving, processing, generating and sending status information on telephones 124 throughout PBX 120, system 204 can manage telephone calls among telephones 124. Call management functions include: recognizing when a telephone 124 goes “off-hook”, initiating a call set-up procedure; managing call processing resources (e.g. dial tones, ring tones, connections) for the pending call; recognizing when a telephone 124 for the call goes “on-hook”, then initiating an appropriate call tear-down procedure to end the call and release any relevant resources. Depending on the current status of the call, appropriate messages and text relating to the call (e.g. the calling/called number, the elapsed time of the call) may be generated and displayed. These messages may be generated by either the telephone directly or by the PBX 120, which can send appropriate messages to the telephone for display. System 204 can track and distribute status information on any telephone 124 to other telephones 124 in PBX 120. This allows PBX 120 to provide call features such as call waiting, call forwarding, call block, voice mail, call return and others. Features can be individually activated and deactivated for individual telephones 124 through PBX 120.

Typically, system 204 is provided in software and operates on a computer enabled device, either as part of PBX controller 200 or through a separate computer. In PBX 120, system 204 is shown as a separate system, but it may be incorporated into PBX 120.

Database 206 is connected to system 204 and stores various operating data for PBX 120, telephones 124 and lines 126, including: extension associations and the current status information of telephones, lines and call processing resources.

It will be appreciated that in a typical office environment, a user of a given telephone 124 will also have a computer 208 at his desk. Computers 208 in the building may be connected through a computer network 210, having computer server 212. Each computer 208 typically has productivity software installed thereon, including word processing software (e.g. WordPerfect—trade-mark), email management software (Exchange—trade-mark) and appointment tracking software (Outlook—trade-mark). Software operating on computer 208 stores its related data (e.g. word processing files, emails, calendar appointments) in its local memory or in a database 216 associated with server 212.

Communication links are also provided between computers 208 and telephones 124. For example: computer 208A may be connected to telephone 124A by communication link 214; computer 208B may be connected to gateway 202 and PBX 120 via connection 218; and a computer 208 may have connections (not shown) to both gateway 202 and telephone 124. Alternatively or additionally, a computer 208 may communicate with a telephone 124 via connection 216 linking server 212 to system 204. As such, files, calendar entries and other data stored in a computer 208 may be provided to PBX 120 and telephone 124. Also, status information for any telephone 124 can be provided to any computer 208 or vice versa. Data can be transmitted among telephone 124, system 204, server 212, elements in network 118 and computer 208 using known messaging and data access techniques.

Data network 118 may be any type of network, such as a local data server, a local LAN network and the Internet. Data network 118 can communicate with server 212 and controller 200 via separate communication links. Voice over IP terminals 102 can be connected to network 118, which in turn communicates with controller 200. Also, in some architectures, remote telephones 124 may also connect to server 212 through network 118.

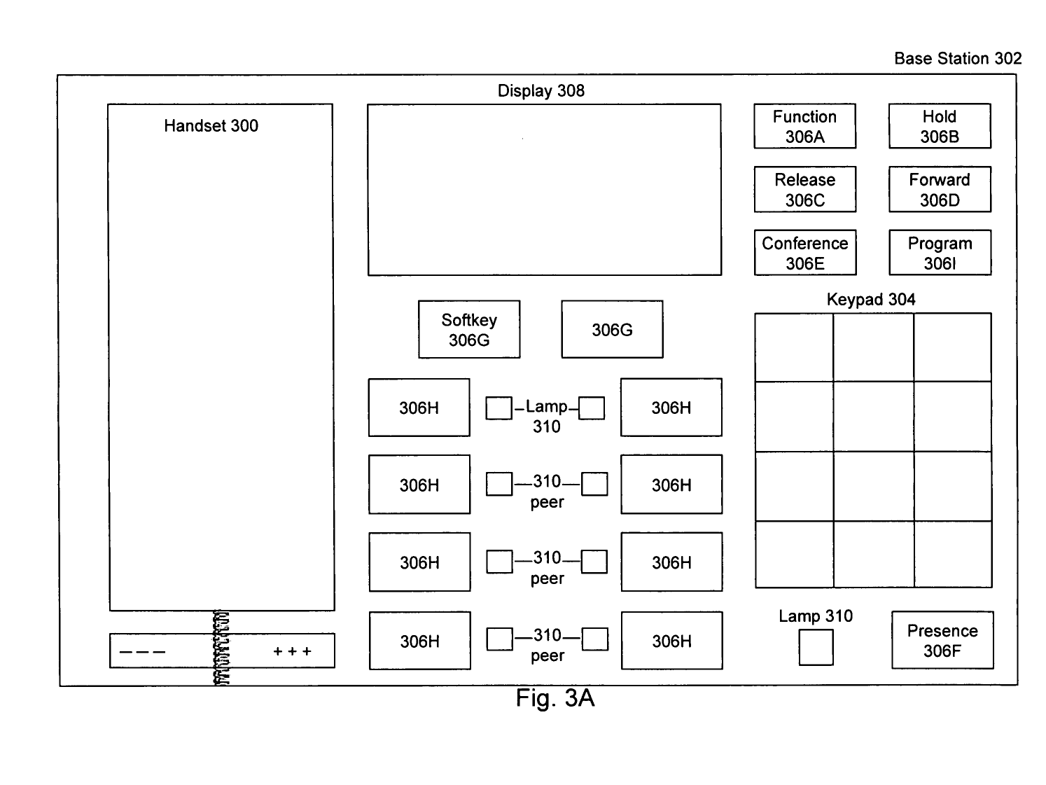

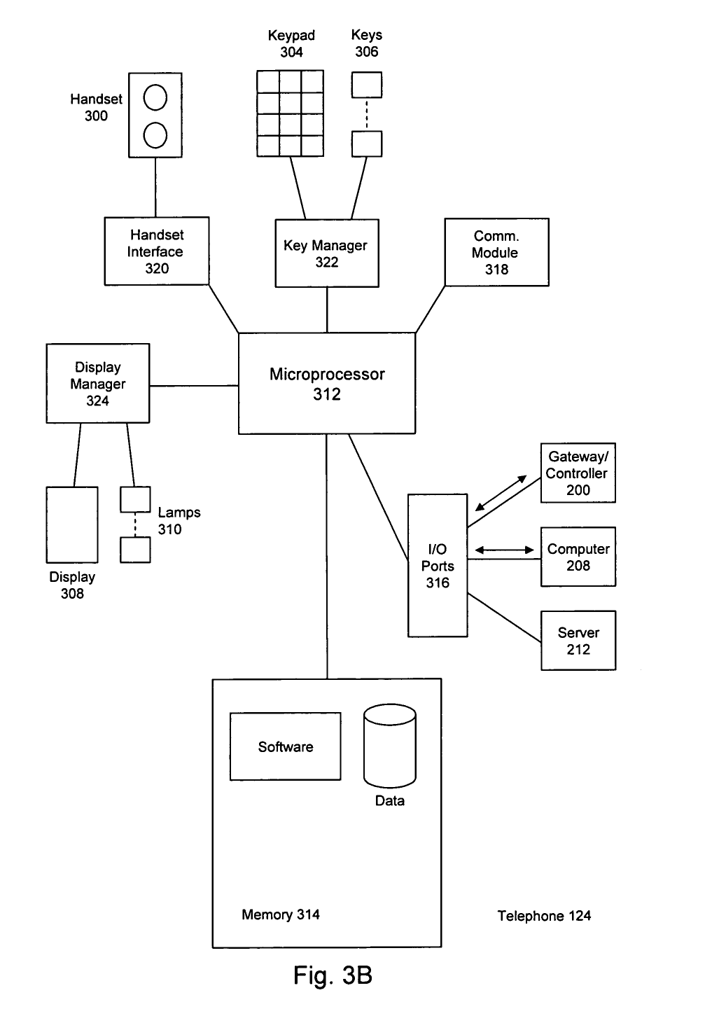

Turning now to exemplary features of an embodiment, FIGS. 3A and 3B provide further detail on telephone 124. As an exterior form factor, telephone 124 has handset 300, base station 302, telephonic keypad 304, function keys 306, display 308 and display lamps 310. Display 308 is either a monochrome or color display capable of producing alphanumeric text and graphics. Lamps 310 are any type of lamp, LED or LCD. They provide quick visual indicators for a predetermined purpose. Typically, lamps 310 can be either on, off, or flash (at different frequencies). The activation of lamps 310 is controlled by software operating on telephone 124.

Function keys 306 provide single button access to various call functions. Several keys 306 are pre-programmed, including: “line” key 306A, which places telephone 124 off-hook without lifting handset 300; “hold key 306B, which places the current call on hold; “release key 306C, which places the call “on-hook”; “forward” key 306D, which forwards incoming calls to another extension; and “conference” key 306E, which allows a three-way call to be initiated. Presence key 306F provides programming for the current status of the telephone 124. Further detail is provided on presence key 306F as descriptions of additional features of an embodiment are provided below. Other functions can be provided on other keys. It will be appreciated that different telephones can have different complements of function keys 306.

Display soft keys 306G are aligned against a portion of display 308. The functions of keys 306G can be dynamically set to have functions that coincide with contexts of messages shown in display 308. For example, if a query is generated on display 308 requiring a Yes or No answer, then a “yes” flag can be generated on display 308 near one key 306G and a “no” flag can be generated on display 308 near another key 306G. Software controlling the two 306G keys are programmed to recognize that activation of either key 306G will represent a “yes” or “no” answer, respectively, to the query. When a user activates one of the two keys 306G, the software reacts according to the answer associated with the activated key 306G.

Soft keys 306H are dynamically programmable and can be assigned different functions. One or more soft keys 306H may be programmed to contain preset telephone numbers. Additionally, one or more lamps 310 may be aligned and associated with one or more soft keys 306H. As such, depending on the function associated with a soft key 306H, the status of its function may be indicated by the activation state of the associated lamp 310.

Internally, telephone 124 has microprocessor 312, memory 314, I/O ports 316, communication module 318, handset interface 320, key manager 322, and display manager 324. Software operating on microprocessor 312 controls operational aspects of telephone 124. The software manages signals received from handset 300, keypad 304, keys 306 and controller 200 in the course of processing a call. As a call is processed or as telephone 124 waits for a call to commence, the software also controls display 308 and lamps 310. Communications module 318 provides a hardware and firmware needed to receive and transmit converted audio signals and secondary data signals to PBX 120. Such signals can be sent through I/O ports 316. Key manager 322 detects activation of any keys 306 and provides appropriate signals to microprocessor 312. Display manager 324 controls generation of text and graphics for display 308 and activation of lamps 310. Handset interface 320 provides a circuit to recognize when handset 300 is either on or off hook and provides appropriate signals to microprocessor 312.

To place a call, a user picks up handset 300, waits to hear a dial tone, enters a number either through keypad 304 or a pre-programmed key then waits to see if the call is completed. When handset 300 is lifted (or a corresponding “line” key 306A is activated), the software operating on telephone 124 generates and sends an appropriate message indicating the status of the telephone (e.g. “off-hook”) to system 204. Such status data is tracked in database 206. As such system 204 has information on the status of all of telephones directly connected to it. An additional message may be provided to computer 208. Alternatively, the status may be provided to computer 208 through server 212, by allowing server 212 to access internal memory of telephone 124 or database 206. Complementary messages may be generated when the called party takes its handset off-hook to complete the call. In such an embodiment, status information about a telephone 124 may be stored locally in storage devices therein. Controller 200 can then poll each telephone 124 through messages to collect status information on each. Alternatively still, each telephone 124 may be able to poll other telephones 124 for their status.

Software on telephone 124 also generates text and graphics for display 308. The text and graphics indicate various states of telephone 124 and its peer telephones 124. For example, the time and date may be generated in a portion of display 308. The data preferably for the time and date is obtained from PBX 120; however, in other embodiments, data may be obtained locally from the telephone. Also, the elapsed time and the telephone number of a current call may be displayed. Certain status information regarding peer telephones 124 may also be provided from data provided from any source, including telephone 124, system 204, computer 208, server 212 and database 216. Further additional status information can be built using data provided from one or such sources.

One feature of an embodiment allows a group of telephones 124 to be recognized as a team of peers. A peer telephone 124 can be programmed to receive status information from other peers. As well, a peer telephone 124 provides its status information to one or more peers. As such, special functions and information can be provided to individual members of a team. For example, up-to-date information on the status of on peers can be provided, including whether a peer is on a call, is out of the office, or has forwarded his telephone number to another number. Team members can define special “speed” transfer keys to allow them to connect immediately to another team member or to create call conferences among two or more team members. Special call access features may be provided to a member of a team. For example, a call interrupt feature can be provided allowing a team member to interrupt a call of another team member . In many instances, each peer telephone 124 provides its status information to all other peers team. In other instances, a peer telephone 124 may provide its status information to one set of peers and it may receive status information from a second set of peers. Further, additional status information for a user associated with a telephone 124 may be provided from his associated computer 208. Any status information sent to or received by a peer telephone 124 in a team may also be sent to or received by computer 208 associated with that peer telephone 124. In other embodiments, teams of teams may be defined. Each member of a certain team may be provided with access and privileged data relating to other teams. It will be appreciated that other organizations of team, sub-teams and related teams can be defined.

Status information for a peer can indicate:
Whether the telephone of the peer is available to be called (yes/no).
How the peer can be called (e.g. through the peer telephone, through an associated GSM telephone, through a digital enhanced cordless telecommunications (DECT) device, or through another communication medium).
Further detail on the peer. For example: (i) Is the peer busy on a call? (ii) Is the user of the peer telephone not in the office? (iii) If the user of the peer telephone is not in the office, when will he return? (iv) If a call is attempted right now, what will be the result (e.g. Will the call be forwarded and if so to whom? Will the call get a busy tone? Will the call be connected to voice mail?).
   Other status information about a telephone 124 or its associated computer 208 can be provided.

On a particular telephone 124, soft keys 306G, lamps 310, display 308 and display keys 306G are used to provide access to its peer telephones 124 in the team and to provide status information on the peer telephones. Further details on the concept of peers and the management of status information for the peers are provided below.

First, a team of peers needs to be defined. The team is typically defined by the users of the telephones 124. A team may have hierarchies, where a member is provided access to information other members based on the level of the member. Once a team of peers has been defined, telephones 124 belonging to the team can have their soft keys 306H programmed to be associated with particular peers. For short form, the reference “key 306Hpeer” will be used to indicate a soft key 306H which has been programmed to represent a particular peer and the reference “lamp 310peer” will be used to indicate a lamp 310 which is associated with key 306Hpeer. Once keys 306Hpeer on a telephone 124 have been programmed, activation of a key 306Hpeer will cause the PBX number associated with that peer to be called by that telephone 124. These numbers and associations may be programmed during installation of telephone 124 into PBX 120.

Second, status information for peers of telephone 124 can be provided by system 204, server 212, computers 208 and other telephones 124. The status information can include one or more of the following states: reachable, unreachable and busy. Additional information may be provided for additional states reflect the status of additional devices associated with the user, for example, the status indicated by the user's email or calendar software on his computer which is near his telephone 124. A “reachable” status may indicate that telephone 124 is not off-hook or is forwarded to another “reachable” telephone number (e.g. an associated GSM telephone number). An “unreachable” status may indicate that telephone 124 has been forwarded to an “unreachable” telephone number (e.g. the telephone number of the user's assistant) or that the telephone cannot be reached currently (e.g. if it is a wireless device, it is out-of-range; a network error has occurred, etc.). A “busy” status may indicate that the peer is on another call. As discussed below, telephone 124 is provided with periodic, updated information on the status of its peers. A “busy” status may be a sub-set of an “unreachable” status.

Telephone 124 also uses lamps 310peer to indicate the status of the peers for that telephone. The status of a lamp 310peer depends on the status of the peer associated with that key 306Hpeer. For example, if the peer is “unreachable”, then lamp 310peer may be activated. If the peer is “reachable”, then the lamp 310peer may be turned off. If the peer is calling telephone 124, in addition to the ring tone generated, lamp 310peer may flash. It will be appreciated that other activation states of lamps 310peer may be used, including using different flashings having different frequencies and duty cycles.

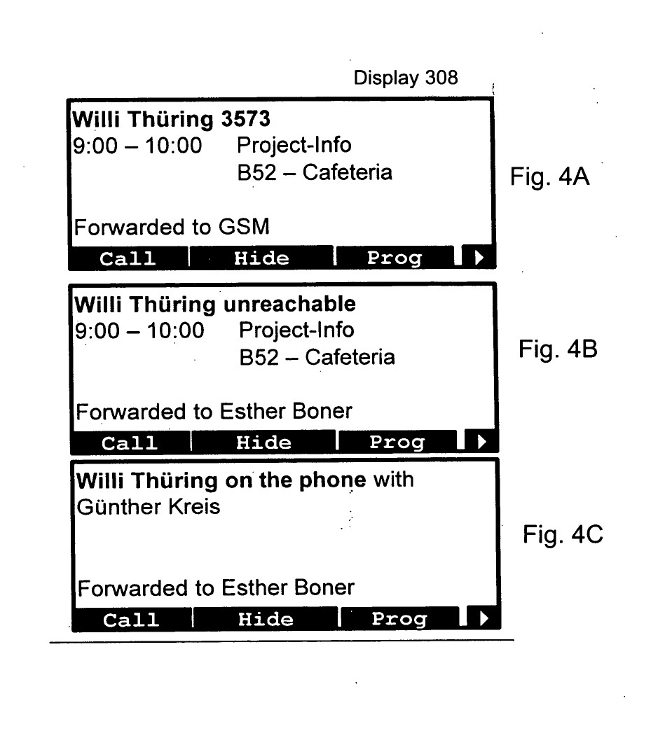

Telephone 124 may also show additional information on a peer on display 308. In one embodiment, key 306Hpeer is also used to initiate a command to display further information about that peer. For example, if key 306Hpeer is activated and held down for a preset amount of time, software operating on telephone 124 recognizes this key sequence as a command to retrieve and display the status information for the peer associated with key 306Hpeer. Thereafter, status information about that peer is gathered and processed by either telephone 124A or PBX 204 and a status message is generated on display 308. FIGS. 4A-4C shows exemplary screen shots generated on display 308 for a “reachable”, “unreachable” and “busy” status.

Additional status information about a peer may also be provided by calendar information tracked by an appointment tracking software operating on the computer 208 associated with the peer telephone 124. As noted earlier, the appointment data processed by computer 208 for the user is available to telephone 124 through either: computer 208, telephone 124 associated, server 212 or system 204. This status information can be incorporated into text on display 308 or a predetermined signal for lamp 310.

The embodiment also allows a user to set an override status the user's telephone 124, regardless of the state indicated by that telephone or the user's appointment software on computer 208. The override status will be captured by PBX 204 and provided to peers of the user, as required.

In telephone 124, presence key 306F is used to set particular override values for the status information. If a user activates key 306F, a text message is generated on display 308, inviting the user to select his desired current “presence” status. The user navigates through the selections of “In a meeting”, “Out of Office” and “On Holiday” and can activate a selection using the navigation keys provided by keys 306D. A presence lamp 310 associated key 306F can be lit according to the status selected. Additional statuses, states and preferences for the user of telephone 124 can be set including: whether telephone 124 is to be forwarded to another number; whether telephone 124A is locked or unlocked for usage; special instructions for calls or inquiries from selected peers; ring characteristics; voice mail announcements, etc. As noted earlier, the status of the user may also be derived from any application entry information stored by appointment software on the user's computer.

Additional features may be provided for the status information of a user, including security features and state transition features. Security features include allowing or disallowing peers to have access to different levels of information regarding the user's current status. For example, different permission levels may be provided to peer of a user: the peer does not have access to the current status information of the user; the peer can see the current status information; the peer can see additional details on the current status information; the peer can change the current status. Similarly, different permission levels may be provided for a peer of a user in regards to the current call status: it cannot see that the user is on a call; it can see that the user is on a call; it can have details of the call during the ring; it can have details of the current call. Such permissions may be set by a supervisor system in the embodiment. The supervisor system may be provided by PBX 120, for example through a process operating on controller 200. Alternatively still, such permissions may be set through software operating on computer 208 associated with telephone 124. Communication of permissions stored on computer 208 may be provided to telephone 124 through the server 212 to controller 200 or directly between computer 208 and telephone 124 when they are directly connected.

Also, if there is a change in the current presence status of the user, the embodiment provides selective notification of the change to selected peers. For example, a new flash sequence may be generated for the lamp 310 associated with the peer, when its status changes.

In order to program keys 306Hpeer, telephone 124 provides a programming mode for soft keys 306Hpeer. To program a particular key 306Hpeer, a peer programming mode needs to be entered on telephone 124. In one embodiment, programming key 306I may be provided to access the programming mode. When key 306I is activated, software operating on telephone 124 recognizes that a soft key 306Hpeer is about to be programmed. Instructions for programming procedures are produced on display 308. Briefly, the user of telephone 124 selects a key 306Hpeer for programming then enters an extension to be associated that key 306Hpeer, using key pad 304. Once the extension is entered, it is stored by the software and the particular key 306Hpeer is now associated with that extension. Alternatively, the programming mode for a particular key may be activated by depressing the key for a predetermined length of time (i.e. initiating a “long click” for that key). Thereafter the programming mode accepts any programmable numbers as described above. The software will then periodically check the status of the telephone associated with the extension, as noted above, and activate associated lamp 310peer, as required.

It will be appreciated that other programming interfaces may be used to program soft keys 306G and peers for telephone 124. In particular, a separate software operating on computer 208 may be provided which has modules providing comparable programming functionalities as noted for telephone 124. It will be appreciated that since the software uses a keyboard and GUI interfaces for entering and displaying information, the programming of peers for telephone 124 can be much simpler through computer 208.

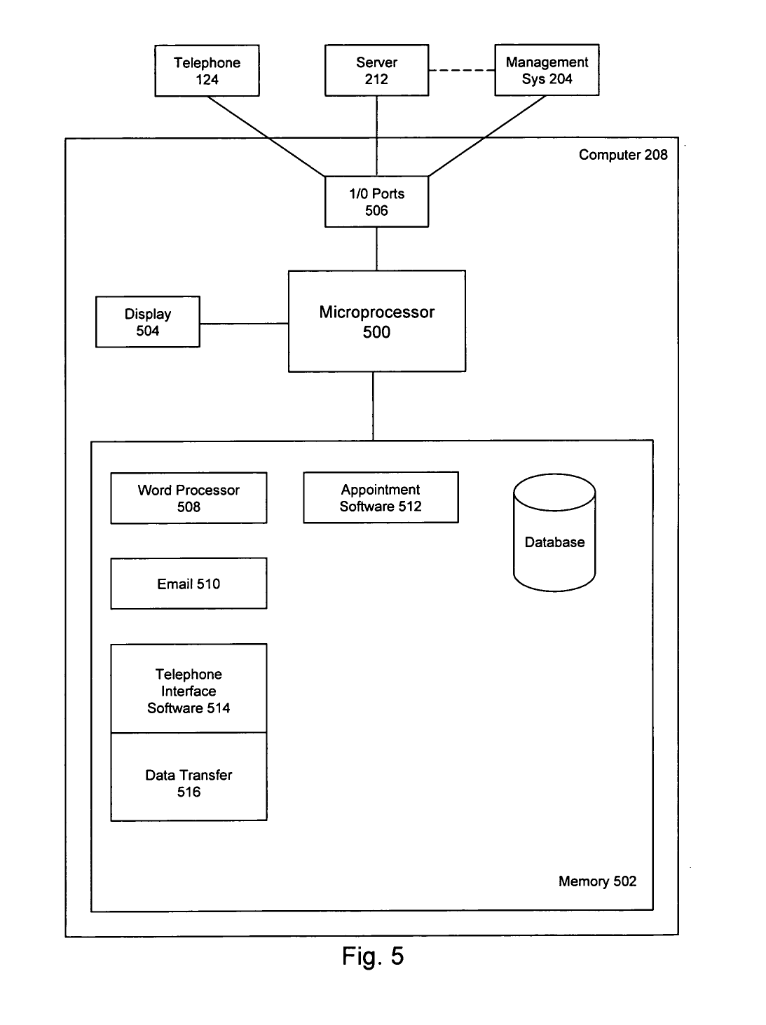

Referring to FIG. 5, further detail is provided on computer 208. Computer 208 has hardware, software and firmware modules installed thereon to facilitate communications and data transfer with telephone 124, system 208, server 212 and other devices in network 100. In one embodiment, data transfers between computer 208A and telephone 124A are made through controlled system 204 and data contained in database 206. In other embodiments, computer 208A can communicate directly with telephone 124A. Computer 208 has the following hardware and firmware elements: microprocessor 500, volatile and non-volatile memory 502, display 504, and I/O ports 506 providing connections to each of telephone 124, system 208 maintenance system 204, database 206 and server 212, as required.

Microprocessor 500 executes instructions provided by software stored in memory 502. As noted earlier, computer 208 may have word processing software 508, email management software 510 and appointment software 512 which are stored either locally in memory 502 or are remotely-accessed through server 212. Appointment software produces calendars and tracks daily availability information of the user of the computer, which can be stored in memory 502.

However, computer 208 preferably also has telephone interface software 514, which provides computer 208 with routines and processes to allow several types of data transfer, including: obtaining status information from telephones 124 to computer 208; providing availability information tracked by other software operating on computer 208 (e.g. information tracked by appointment software 512) to PBX 120 and ultimately telephones 124; programming individual features for team members; and updating status information on telephones 124. Exemplary situations describing a scenario of each type of data transfer have been noted earlier. Specifically, data transfer module 516 in telephone interface software 514 is provided to access and update the status information stored in telephone 124, system 204, database 206 and memory 502.

Telephone interface software 514 obtains such status information by generating and sending queries directly to a target (such as another telephone 124, PBX system 120, server 212, appointment software 512 or another computer 208), and then waiting for a response. Information can also be obtained from programs operating on computer 208, including messaging programs (email programs, ICQ programs and their related data). Data can also be retrieved or generated from software operating on computer 208, such as messaging software (including email programs, ICQ programs and their related data). Alternatively, such status information may be extracted directly from the target, if such access is allowed. Other data transfer techniques can be used following techniques known in the art.

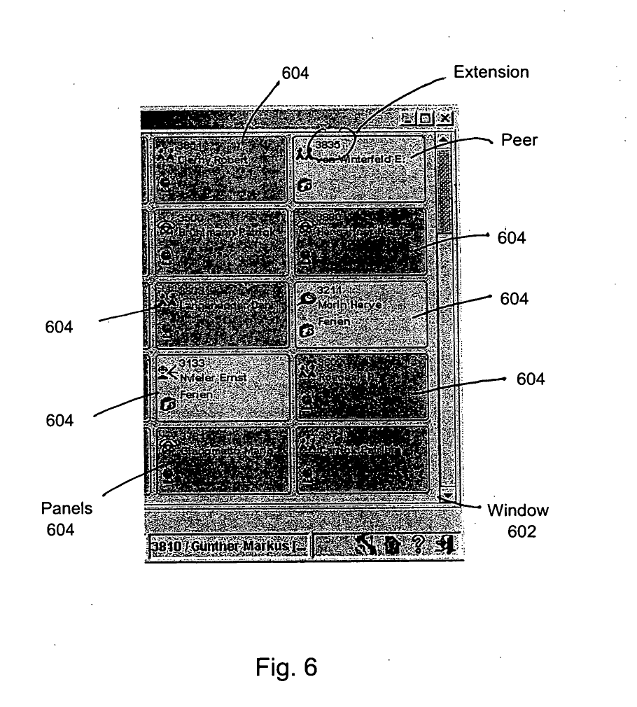

Referring to FIG. 6, in view of the above, computer 208 has status knowledge of telephone 124, its identified peers and any appointment entries for its user. Telephone interface software 514 uses the obtained status information of peers of its associated telephone 124 and generates graphical information on display 504.

An exemplary display of screen shot 600 generated by telephone interface software 514 is shown. Screen shot 600 shows a window 602 with several panels 604 located therein. Each panel 604 provides a snapshot of the current status of a peer telephone 124 to the telephone 124 associated with the computer 208 executing the software.

Icons and text provide the identification data for a peer and provide information as to whether the peer can be reached. For example, if the peer can be reached, the icons and text can indicate how the peer can be reached, e.g. whether through his telephone 124, through an associated GSM or DECT phone or another system. If the peer cannot be reached, then the icons and text can indicate the user's current status. The current status may be derived from status information obtained from the peer's telephone 124 or the peer's associated computer 208. For example, using status information from the peer's telephone, the icons can indicate if the user's telephone 124: is busy; is forwarded to a third party, is forwarded to the voice mail system; or is on a call and display the other party's number. Also, using status information from the peer's computer 208, the icons can indicate if the user is: in a scheduled meeting; available; or busy (and provide notes indicating his current location and estimated time of return). Other status information may be provided, depending on the types of information stored by computer 208 and telephone 124. Different visual keys may be used to highlight the current status of a peer. For example, background colors of a panel may be changed, backgrounds may flash, or any other visual enhancement technique may be used.

The above noted embodiment describes a system wherein status information for peers in a PBX system. In other embodiments, one or more peers may be provided in across different networks.

It will be appreciated from the above examples that additional status information, peer connections may be provided to a telephone, communication device or other terminal connected to one or more communication networks which may be other embodiments of the invention. Although the invention has been described with reference to certain specific embodiments, various modifications thereof will be apparent to those skilled in the art without department from the spirit and scope of the invention as outlined in the claims appended hereto.

We claim:

1. A system for providing status information relating to a first communication device in a communication network, said system comprising:
a database storing status information regarding availability of said first communication device;
a data access system to access said database in order to retrieve and transmit said status information; and
a second communication device to receive said status information from said data access system, second communication device comprising
a display providing information relating to said status information; and
software operating thereon to control said indicator provides said visual indication and how said display provides said status information,
wherein
if said first communication device is reachable, said display provides information regarding a manner in which said first communication device may be reached; and
if said first communication device is not reachable, said display provides information indicating that said first communication device is not reachable.

2. The system for providing status information relating to a first communication device as claimed in claim 1, wherein said second device further comprises a lamp indicator selectively providing a visual indication of said status information.

3. The system for providing status information relating to a first communication device as claimed in claim 2, wherein said lamp indicator is located near said display and provides said visual indication of said status information in conjunction with related status information generated on said display.

4. The system for providing status information relating to a first communication device as claimed in claim 3, further comprising availability information provided by an appointment program operating on a computer associated with said first communication device, said availability information being provided to said second communication device by said data access system and being displayed on said display of said second communication device.

5. The system for providing status information relating to a first communication device as claimed in claim 4, further comprising status information on a third communication device stored in said database and provided to said second communication device by said data access system.

6. The system for providing status information relating to a first communication device as claimed in claim 5, wherein said availability information of said first communication device indicates when said first communication device has had its telephone number forwarded to another number.

7. The system for providing status information relating to a first communication device as claimed in claim 5, wherein said availability information of said first communication device indicates when said first communication device is connected to another call.

8. The system for providing status information relating to a first communication device as claimed in claim 5, wherein said second communication device further comprises
an interface to set an override value for a current status for said second communication device.

9. The system for providing status information relating to a first communication device as claimed in claim 8, further comprising
a second computer associated with said second communication device, said second computer being provided with said status information; and
software operating on said second computer to access and display said status information on a display associated with said second computer.

10. The system for providing status information relating to a first communication device as claimed in claim 9, wherein
a permission level providing a selectable amount of detail relating to said status information can be set at said second computer.

11. The system for providing status information relating to a first communication device as claimed in claim 10, further comprising a supervisor system external to said second computer setting said permission level.

12. The system for providing status information relating to a first communication device as claimed in claim 11, wherein said supervisor system is provided by a controller for said first communication device.

13. The system for providing status information relating to a first communication device as claimed in claim 12, wherein said software operating on said second computer provides said status information through a GUI, wherein said GUI utilizes at least one of color, icons and text to signify aspects of said status information.

14. A method for providing status information to a communication device connected to a communication network relating to a plurality of communication devices also connected to said communication network, said method comprising:
tracking current availability of each communication device of said plurality of communication devices utilizing status information associated with said each communication device through said communication network; and
providing to said communication device details regarding said current availability of said each communication device information utilizing said status information,
wherein
if said each communication device is reachable, said details provide information regarding a manner in which said each communication device may be reached; and
if said each communication device is not reachable, said details provide information indicating that said each communication device is not reachable.

15. The method for providing status information to a communication device connected to a communication network as claimed in claim 14, wherein additional availability information is provided from an appointment program operating on a computer associated with said each communication device to said communication device.

16. The method for providing status information to a communication device connected to a communication network as claimed in claim 15, wherein said current availability indicates when said each communication device has had its number forwarded to another number.

17. The method for providing status information to a communication device connected to a communication network as claimed in claim 16, wherein said current availability indicates when said each communication device is connected to another call.
